(19) United States
(12) Patent Application Publication
(10) Pub. No.: US 2020/0302551 A1
(43) Pub. Date: Sep. 24, 2020

(54) Systems and Methods for Managing Digital Receipts

(71) Applicant: Dime Technologies Inc., Parkland, FL (US)

(72) Inventor: Dino Petrovic, Parkland, FL (US)

(21) Appl. No.: 16/822,298

(22) Filed: Mar. 18, 2020

Related U.S. Application Data
(60) Provisional application No. 62/819,928, filed on Mar. 18, 2019.

(51) Int. Cl. G06Q 40/00; G06Q 20/20; G06Q 40/02; G06Q 20/04; G06F 16/14

(52) U.S. Cl. CPC G06Q 40/12; G06Q 20/209; G06F 16/148; G06Q 20/047; G06Q 20/202; G06Q 40/02

(57) ABSTRACT

Digital receipts, in the form of image files and/or raw text files, can be generated during consummation of transactions at points of sale and then sent (e.g., via email) to a centralized server for warehousing. The centralized server can warehouse the digital receipts by associating them with transaction and/or member records based, at least in part, upon data collected at the respective point of sale during consummation of the respective transaction (e.g., banking account numbers, customer identification numbers, transaction amounts, and/or transaction time stamps). The centralized server can also forward digital receipts to recipient servers, such as financial institution servers (e.g., for association with a bank customer's on-line banking information) or money management platform servers (e.g., for association with a customer's on-line expense tracking software).

### CROSS-REFERENCE TO RELATED APPLICATIONS

This application claims the benefit of U.S. provisional application No. 62/819,928, filed 18 Mar. 2019, which is hereby incorporated by reference as though fully set forth herein.

### BACKGROUND

The present disclosure relates generally to the purchase of goods and services. In particular, the present disclosure relates to systems and methods for managing records of consumer transactions.

As those of ordinary skill in the art will appreciate, when a consumer enters into a transaction for goods and/or services, whether at a brick-and-mortar location or an online shop, the merchant typically generates an itemized record of the transaction, referred to herein as a “receipt.” For instance, brick and mortar merchants typically provide the consumer with a printed receipt at the point of sale, and may alternatively or additionally offer to send an electronic version of the printed receipt to the consumer by email, text message, or the like. Online merchants generally send a receipt to consumer-designated email addresses, and may alternatively or additionally include a printed copy of the receipt in shipments of goods.

Regardless of how receipts are delivered, however, they are the consumer's burden to manage. Such management can be cumbersome and is often done only on an ad hoc basis.

For example, a business traveler preparing an expense report following a business trip may need to collate an airfare receipt sent to a first email address, a hotel receipt sent to a second email address, taxi receipts sent by text message to the traveler's cell phone, and paper meal receipts.

As another example, because many manufacturers deny warranty claims without proof of purchase, consumers may need to choose between retaining their receipts or foregoing their warranty remedies.

### BRIEF SUMMARY

Disclosed herein is a method of managing digital receipts. The method includes: receiving at a centralized server, from a plurality of points of sale (which may be distributed across a plurality of different merchants), a plurality of digital receipts, wherein each digital receipt of the plurality of digital receipts includes itemized details for a transaction consummated at a point of sale of the plurality of points of sale, and wherein the receiving of each digital receipt of the plurality of digital receipts occurs automatically upon consummation of the respective transaction at the respective point of sale; and the centralized server associating each digital receipt with at least one of a transaction record and a member record based at least in part upon data collected at the respective point of sale during consummation of the respective transaction.

The plurality of digital receipts can include a plurality of image files, a plurality of raw text files, and/or a plurality of PDF files.

The data collected at the respective point of sale during consummation of the respective transaction can include a banking account number, such as a credit card number, a customer identification number, an amount of the respective transaction, and/or a time stamp of the respective transaction.

In embodiments, the method also includes the centralized server forwarding at least one digital receipt of the plurality of digital receipts to a recipient server, such as a financial institution server associated with a financial association associated with a payment method used during consummation of the respective transaction. The centralized server may identify the recipient server based at least in part upon the data collected at the respective point of sale during consummation of the respective transaction.

It is also contemplated that the centralized server may receive a transaction search query and return at least one digital receipt of the plurality of digital receipts responsive to the transaction search query.

Also disclosed herein is a method of managing digital receipts, including: automatically generating, at a point of sale during consummation of a transaction, a digital receipt, wherein the digital receipt includes itemized details for the transaction; and the point of sale transmitting the digital receipt to a centralized server for association with at least one of a member record and a transaction record.

The method can also include collecting, at the point of sale during consummation of the transaction, data to facilitate association of the digital receipt with the member record by the centralized server. The data may include a banking account number, such as a credit card number, a customer identification number, an amount of the transaction, and/or a time stamp of the transaction.

The present disclosure also provides a non-transitory computer readable medium having embodied thereon computer readable code for managing digital receipts that, when executed by a computer or processor, causes the computer or processor to: receive, from a plurality of points of sale, a plurality of digital receipts, wherein each digital receipt of the plurality of digital receipts includes itemized details for a transaction consummated at a point of sale of the plurality of points of sale, and wherein the receiving of each digital receipt of the plurality of digital receipts occurs automatically upon consummation of the respective transaction at the respective point of sale; and associate each digital receipt with at least one of a transaction record and a member record based at least in part upon data collected at the respective point of sale during consummation of the respective transaction.

In an additional embodiment, the present disclosure relates to a non-transitory computer readable medium having embodied thereon computer readable code for managing digital receipts that, when executed by a computer or processor at a point of sale during consummation of a transaction, causes the computer or processor to: automatically generate a digital receipt, wherein the digital receipt includes itemized details for the transaction; and transmit the digital receipt to a centralized server for association with at least one of a member record and a transaction record.

An advantage of the present disclosure is that it centralizes the management and storage of receipts, thereby reducing the burden on the consumer.

Another advantage of the present disclosure is that it facilitates processes that require receipts, such as the preparation of expense reports, the preparation of tax returns, the return of goods, warranty claims, and the like.

Still another advantage of the present disclosure is that it facilitates the analysis of spending patterns, which may be desirable when developing household budgets.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic representation of a system architecture according to aspects of the present disclosure.

While multiple embodiments are disclosed, still other embodiments of the present disclosure will become apparent to those skilled in the art from the following detailed description, which shows and describes illustrative embodiments. Accordingly, the drawings and detailed description are to be regarded as illustrative in nature and not restrictive.

### DETAILED DESCRIPTION

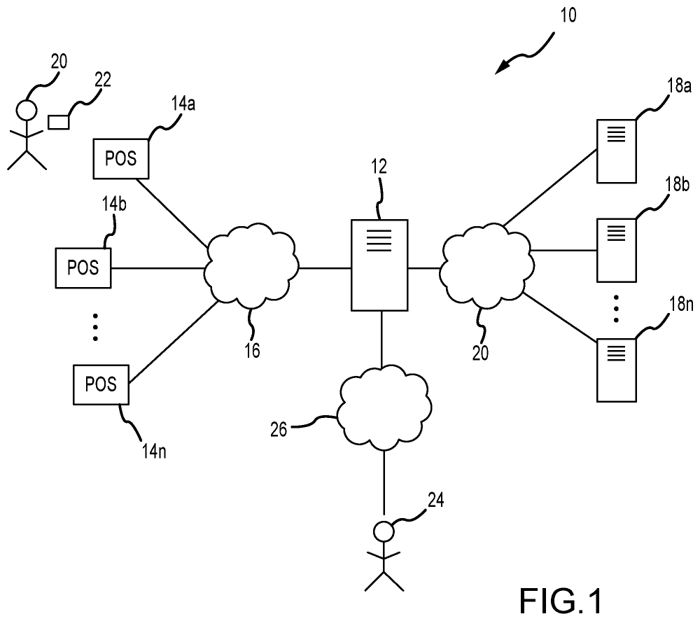

FIG. 1 schematically depicts a representative system architecture 10 that can be used to implement methods of managing digital receipts according to aspects of the present disclosure. For purposes of illustration, aspects of the present disclosure will be explained herein with reference to a transaction between an individual consumer and a merchant (e.g., a provider of goods and/or services). It should be understood, however, that the teachings herein can be applied to good advantage in connection with other transactions including, without limitation, business-to-business transactions.

More particularly, FIG. 1 depicts a centralized server 12 linked to a plurality of points of sale 14a-14n via a network 16, such as the Internet. As used herein, the term “point of sale” refers to the point at which a transaction is consummated and encompasses not just physical locations (e.g., the checkout line at a grocery store), but also online processes (e.g., the checkout process at an online shop). Advantageously, points of sale 14a-14n as disclosed herein may be distributed across a plurality of different merchants. Put another way, points of sale 14a-14n need not all be in the same merchant location (e.g., all checkout lanes in a given grocery store location), or even in different locations for the same merchant (e.g., all checkout lanes across locations of a single grocery store chain), but rather may belong to different merchants entirely.

As shown in FIG. 1, a customer 20 consummates a transaction at a point of sale (e.g., 14a), for instance by tendering payment for goods and/or services via a credit card 22. Of course, other payment methods are within the scope of the present disclosure.

According to aspects of the disclosure, point of sale 14a generates a digital receipt when the transaction is consummated. In embodiments of the disclosure, point of sale 14a automatically generates the digital receipt. For purposes of this disclosure, the term “automatic,” and its various forms, refers to acts that occur without further user intervention. Thus, when point of sale 14a automatically generates the digital receipt, it does so sometime after the transaction is consummated without further intervention by customer 20 and/or the merchant. It is desirable, however, for the events (that is, consummation of the transaction and generation of the digital receipt) to occur within a relatively short time (e.g., within 24 hours of the consummation of the transaction, and more desirably within several minutes of the consummation of the transaction).

Like a traditional receipt, the digital receipt is a record of the transaction, including itemized details thereof. Indeed, in some embodiments of the disclosure, the digital receipt may be an electronic copy of the printed receipt handed to consumer 20 at the point of sale.

Once the digital receipt is generated, point of sale 14a automatically transmits it to centralized server 12 over network 16. In this regard, the digital receipt can take the form of an image file (e.g., JPEG, PDF), a raw text file, or any other file format suitable for transmission over network 16 to centralized server 12. Again, the transmission to centralized server 12 occurs without further user intervention, desirably within a relatively short time (e.g., within 24 hours of the consummation of the transaction, and more desirably within several minutes of the consummation of the transaction).

In embodiments of the disclosure, point of sale 14a transmits the digital receipt to centralized server 12 via email. For instance, point of sale 14a can email the digital receipt to an email address in the form of CARDNUMBER@DOMAIN, where “CARDNUMBER” is the number of the payment card presented by consumer 20 at point of sale 14a, and “DOMAIN” is the email domain for centralized server 12.

Centralized server 12, in turn, associates the received digital receipt with a member record and/or a transaction record. As used herein, the term “member record” refers to a record pertaining to consumer 20; one example of a member record is a customer loyalty account. As used herein, the term “transaction record” refers to a record pertaining to the particular transaction being consummated; one example of a transaction record is a charge posted to a credit card account.

In embodiments of the disclosure, centralized server 12 associates the received digital receipt with the member and/or transaction records using additional data collected from and/or about consumer 20 and/or the transaction by point of sale 14a. That is, the additional data facilitates matching by centralized server 12 of the received receipt with a particular transaction and/or a particular consumer.

In this regard, the additional data can include, without limitation: customer identification numbers (e.g., a unique membership and/or loyalty account number presented/input by customer 20 at point of sale 14a, such as by scanning a membership credential (e.g., a membership card or RFID token) or by manual input (e.g., keying in a phone number at point of sale 14a)), financial account numbers (e.g., the credit card or debit card number presented by customer 20 at point of sale 14a), dollar amounts (e.g., the amount of the transaction consummated by customer 20 at point of sale 14a), time stamps (e.g., the date and time at which customer 20 consummated the transaction at point of sale 14a), and the like.

Those of ordinary skill in the art will appreciate from the foregoing disclosure that centralized server 12 thus maintains a database of a plurality of digital receipts, each associated with a member record and/or a transaction record. Accordingly, it is also contemplated that server 12 can receive a query from a user 24 via a network 26 (e.g., the Internet) seeking to retrieve one or more digital receipts corresponding to one or more transactions that user 24 consummated; server 12 can execute the query and return any responsive results to user 24 over network 26.

In additional aspects of the disclosure, centralized server 12 can be linked to a plurality of recipient servers 18a-18n via a network 20, which may also be the Internet. For instance, it is contemplated that one or more financial institutions may have connections to centralized server 12, such that a digital receipt can be forwarded from centralized server 12 to the financial institution that holds the payment account used by consumer 20 at point of sale 14a. Advantageously, consumer 20 can then access the digital receipt not only through a query to centralized server 12, but also directly through his or her financial institution (e.g., via online and/or mobile banking functionality).

Although several embodiments have been described above with a certain degree of particularity, those skilled in the art could make numerous alterations to the disclosed embodiments without departing from the spirit or scope of this invention.

For example, in addition to forwarding digital receipts to one or more financial institutions as discussed above, centralized server 12 can alternatively or additionally forward digital receipts to accounting, expense, and money management platforms such as Intuit QuickBooks™, Intuit Mint, SAP Concur®, and the like.

As another example, the payment card account number in the email address CARDNUMBER@DOMAIN described above could be replaced by a unique customer number, such as a customer loyalty account number or member number.

As yet another example, digital receipts need not be received directly from points of sale 14a-14n at centralized server 12. Indeed, it is expressly contemplated that points of sale 14a-14n may transmit digital receipts to one or more intervening servers (e.g., local servers at a particular retail location and/or a retail chain's corporate server) before being transmitted to centralized server 12.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of managing digital receipts, comprising:
receiving at a centralized server, from a plurality of points of sale, a plurality of digital receipts,
wherein each digital receipt of the plurality of digital receipts includes itemized details for a transaction consummated at a point of sale of the plurality of points of sale, and
wherein the receiving of each digital receipt of the plurality of digital receipts occurs automatically upon consummation of the respective transaction at the respective point of sale; and
the centralized server associating each digital receipt with at least one of a transaction record and a member record based at least in part upon data collected at the respective point of sale during consummation of the respective transaction.

2. The method according to claim 1, wherein the plurality of digital receipts comprises a plurality of image files.

3. The method according to claim 1, wherein the plurality of digital receipts comprises a plurality of raw text files.

4. The method according to claim 1, wherein the plurality of digital receipts comprises a plurality of PDF files.

5. The method according to claim 1, wherein the data collected at the respective point of sale during consummation of the respective transaction comprises a banking account number.

6. The method according to claim 1, wherein the data collected at the respective point of sale during consummation of the respective transaction comprises a customer identification number.

7. The method according to claim 1, wherein the data collected at the respective point of sale during consummation of the respective transaction comprises a credit card number.

8. The method according to claim 1, wherein the data collected at the respective point of sale during consummation of the respective transaction comprises an amount of the respective transaction.

9. The method according to claim 1, wherein the data collected at the respective point of sale during consummation of the respective transaction comprises a time stamp of the respective transaction.

10. The method according to claim 1, further comprising the centralized server forwarding at least one digital receipt of the plurality of digital receipts to a recipient server.

11. The method according to claim 10, further comprising the centralized server identifying the recipient server based at least in part upon the data collected at the respective point of sale during consummation of the respective transaction.

12. The method according to claim 10, wherein the recipient server comprises a financial institution server.

13. The method according to claim 12, wherein the financial institution server is associated with a financial institution associated with a payment method used during consummation of the respective transaction.

14. The method according to claim 1, further comprising:
the centralized server receiving a transaction search query; and
the centralized server returning at least one digital receipt of the plurality of digital receipts responsive to the transaction search query.

15. The method according to claim 1, wherein the plurality of points of sale are distributed across a plurality of different merchants.

16. A method of managing digital receipts, comprising:
automatically generating, at a point of sale during consummation of a transaction, a digital receipt, wherein the digital receipt includes itemized details for the transaction;
the point of sale transmitting the digital receipt to a centralized server for association with at least one of a member record and a transaction record.

17. The method according to claim 16, further comprising collecting, at the point of sale during consummation of the transaction, data to facilitate association of the digital receipt with the member record by the centralized server.

18. The method according to claim 17, wherein the data comprises a banking account number.

19. The method according to claim 18, wherein the data comprises a credit card number.

20. The method according to claim 17, wherein the data comprises a customer identification number.

21. The method according to claim 17, wherein the data comprises an amount of the transaction.

22. The method according to claim 17, wherein the data comprises a time stamp of the transaction.

23. A non-transitory computer readable medium having embodied thereon computer readable code for managing digital receipts that, when executed by a computer or processor, causes the computer or processor to:
receive, from a plurality of points of sale, a plurality of digital receipts,
wherein each digital receipt of the plurality of digital receipts includes itemized details for a transaction consummated at a point of sale of the plurality of points of sale, and
wherein the receiving of each digital receipt of the plurality of digital receipts occurs automatically upon consummation of the respective transaction at the respective point of sale; and
associate each digital receipt with at least one of a transaction record and a member record based at least in part upon data collected at the respective point of sale during consummation of the respective transaction.

24. A non-transitory computer readable medium having embodied thereon computer readable code for managing digital receipts that, when executed by a computer or processor at a point of sale during consummation of a transaction, causes the computer or processor to:
automatically generate a digital receipt, wherein the digital receipt includes itemized details for the transaction; and
transmit the digital receipt to a centralized server for association with at least one of a member record and a transaction record.
